(19) United States
(12) Patent Application Publication
(10) Pub. No.: US 2026/0091942 A1
(43) Pub. Date: Apr. 2, 2026

(54) SCATTERED-MATERIAL CLEANING ROBOT USED FOR CONVEYOR

(71) Applicant: TAIYUAN UNIVERSITY OF TECHNOLOGY, Taiyuan, Shanxi (CN)

(72) Inventors: Ziming KOU, Taiyuan (CN); Guijun GAO, Taiyuan (CN); Cong HAN, Taiyuan (CN); Haiqing WANG, Taiyuan (CN); Lei LYU, Taiyuan (CN); Jiabao XUE, Taiyuan (CN); Zhigang LI, Taiyuan (CN)

(21) Appl. No.: 19/113,215

(22) PCT Filed: Aug. 31, 2023
(86) PCT No.: PCT/CN2023/116147

§ 371 Date: Mar. 19, 2025

(30) Foreign Application Priority Data
Sep. 19, 2022 (CN) 202211139642.0

(51) Int. Cl. B65G 45/14

(52) U.S. Cl. CPC B65G 45/14; B65G 2201/042

(57) ABSTRACT

A scattered material cleaning robot for a conveyor includes a housing, a feeding assembly, a discharging assembly and a lifting assembly disposed on the housing. The feeding assembly is configured to collect scattered materials, the discharging assembly is disposed above the feeding assembly, and the discharging assembly is configured to deliver the scattered materials collected by the feeding assembly to the conveyor. The lifting assembly includes a flexible transmission mechanism and at least one material carrying member. One of two ends of the flexible transmission mechanism is located at the feeding assembly, and another one of the two ends of the flexible transmission mechanism is located at the discharging assembly. The flexible transmission mechanism is configured to drive the material carrying member to move between the feeding assembly and the discharging assembly, to convey the scattered materials from the feeding assembly to the discharging assembly.

### CROSS-REFERENCE TO RELATED APPLICATION

The present disclosure is a national stage of International Application No. PCT/CN2023/116147 filed on Aug. 31, 2023, which claims priority to Chinese Patent Application No. 202211139642.0 filed on Sep. 19, 2022. The disclosures of International Application No. PCT/CN2023/116147 and Chinese Patent Application No. 202211139642.0 are hereby incorporated by reference in their entireties.

### TECHNICAL FIELD

Embodiments of the present disclosure relate to, but are not limited to, the technical field of material conveying, and particularly relate to a scattered material cleaning robot for a conveyor.

### BACKGROUND

A conveyor is a widely used equipment configured to convey various scattered materials such as a granular material, a powdery material and the like. Some of these materials contain moisture. The conveyor is of a belt type, a screw type, and the like. In a humid environment, the viscosity of the materials is particularly large. If the materials attached to a working surface such as a conveyor belt are not discharged cleanly during discharging, they will be scattered below a lower carrier roller.

In a related art, a scattered material cleaning mechanism is fixed to the conveyor, the scattered materials contaminated outside and inside the belt can be cleaned through a bristle roller brush, and the scraped scattered materials can fall into a recycle chamber through a scraper and a brush.

In the above scheme, the cleaning mechanism can only clean the scattered materials contaminated on the belt, it is difficult to clean and recover the materials scattered below the belt, and the cleaning mechanism is immobilized relative to the conveyor, which leads to a limited cleaning range.

### SUMMARY

A scattered material cleaning robot for a conveyor provided by embodiments of the present disclosure has a wide operation range and can clean scattered materials on the ground.

An embodiment of the present disclosure provides a scattered material cleaning robot for a conveyor. The scattered material cleaning robot for the conveyor includes a body, a lifting assembly, and a driving assembly. The body is movable relative to the conveyor. The body includes a housing, a feeding assembly and a discharging assembly, and the feeding assembly and the discharging assembly are disposed on the housing. The feeding assembly is configured to collect scattered materials, the discharging assembly is disposed above the feeding assembly, and the discharging assembly is configured to deliver the scattered materials collected by the feeding assembly to the conveyor. The lifting assembly is disposed in the housing, and the lifting assembly includes a flexible transmission mechanism and at least one material carrying member. One of two ends of the flexible transmission mechanism is located at the feeding assembly, and another one of the two ends of the flexible transmission mechanism is located at the discharging assembly. The flexible transmission mechanism is configured to drive the at least one material carrying member to move between the feeding assembly and the discharging assembly, to convey the scattered materials from the feeding assembly to the discharging assembly. The driving assembly is configured to drive the body and the flexible transmission mechanism to move.

In the scattered material cleaning robot for the conveyor provided by the embodiment of the present disclosure, the body is movable relative to the conveyor, thereby moving to a position where the scattered materials are located. In this way, the robot of the present disclosure can clean the scattered materials in a wider range, and the operation range of the robot of the present disclosure is improved. One robot can clean the scattered materials at a plurality of different positions, and compared with a situation that each scattered material position is provided with one cleaning mechanism, the robot of the present disclosure is more economical and can reduce the occupation of space around the conveyor by the cleaning mechanism. Specifically, the body includes a housing, a feeding assembly and a discharging assembly, and the feeding assembly and the discharging assembly are disposed on the housing. The feeding assembly is configured to collect scattered materials, the discharging assembly is disposed above the feeding assembly, and the discharging assembly is configured to deliver the scattered materials collected by the feeding assembly to the conveyor. In addition, the robot of the present disclosure is further provided with a lifting assembly in the housing, to convey the scattered materials collected by the feeding assembly to the discharging assembly. Specifically, the lifting assembly includes a flexible transmission mechanism and at least one material carrying member. The at least one material carrying member is configured to carry the scattered materials. One of two ends of the flexible transmission mechanism is located at the feeding assembly, and another one of the two ends of the flexible transmission mechanism is located at the discharging assembly. The flexible transmission mechanism is configured to drive the at least one material carrying member to move between the feeding assembly and the discharging assembly, to convey the scattered materials from the feeding assembly to the discharging assembly. Due to the arrangement of the lifting assembly, the scattered materials can be conveyed from a lower position to a higher position, to allow the feeding assembly to be disposed at any height below the conveyor belt for collecting the scattered materials. For example, the feeding assembly is disposed on the ground, and the scattered materials on the ground are collected by the feeding assembly and then are conveyed to the discharging assembly through the lifting assembly. Compared with the scheme in a related art in which the cleaning mechanism is immobilized relative to the conveyor and can only clean the scattered materials contaminated on the conveyor belt, the robot of the present disclosure is movable, and thus has a larger operation range, and due to the arrangement of the lifting assembly, the scattered materials can be conveyed from a lower position to a higher position, to allow the robot to clean and recover the scattered materials below the conveyor belt, such as the scattered materials on the ground.

In a possible implementation of the present disclosure, the flexible transmission mechanism includes a first sprocket, a second sprocket and an annular chain. Each of the first sprocket and the second sprocket is rotatably connected to the housing. One of the first sprocket and the second sprocket is connected to the driving assembly for transmission. The first sprocket is located at the feeding assembly, and the second sprocket is located at the discharging assembly. One of two ends of the annular chain is wrapped around the first sprocket, and another one of the two ends of the annular chain is wrapped around the second sprocket. The at least one material carrying member is fixed to an outer side of the annular chain.

In a possible implementation of the present disclosure, the flexible transmission mechanism further includes an auxiliary wheel and a first sheave. Each of the auxiliary wheel and the first sheave abuts against a respective one of an inner side and the outer side of the annular chain in a same direction, to allow the flexible transmission mechanism to form a first transmission section and a second transmission section. The first transmission section is arranged horizontally and includes the first sprocket, a preset angle is formed between the second transmission section and the first transmission section, and the second transmission section includes the second sprocket.

In a possible implementation of the present disclosure, the flexible transmission mechanism further includes a second sheave abutting against an outer side of the second transmission section, to allow the annular chain to form a non-block recess below the second sprocket. The discharging assembly is arranged at the non-block recess.

In a possible implementation of the present disclosure, a circumferential side of the first sheave is provided with at least one first non-block notch, a circumferential side of the second sheave is provided with at least one second non-block notch, and each of the first non-block notch and the second non-block notch is configured to unblock the at least one material carrying member.

In a possible implementation of the present disclosure, the scattered material cleaning robot further includes a spacer plate fixed to the housing, the spacer plate is arranged on an inner side of the second transmission section, and the spacer plate extends along a profile of the annular chain.

In a possible implementation of the present disclosure, the body further includes a traveling component, the traveling component includes a wheel axle, a traveling wheel, and an adjusting mechanism, and the wheel axle is rotatably connected to the housing. The traveling wheel is rotatably connected to the wheel axle, and the traveling wheel is movable in an axial direction of the wheel axle to a first position and a second position. The adjusting mechanism includes a first traveling driven wheel and a second traveling driven wheel arranged around the wheel axle. Each of the first traveling driven wheel and the second traveling driven wheel is connected to the driving assembly for transmission, and a rotation direction of the first traveling driven wheel is opposite to a rotation direction of the second traveling driven wheel. When the traveling wheel moves to the first position, the traveling wheel rotates in synchronization with the first traveling driven wheel. When the traveling wheel moves to the second position, the traveling wheel rotates in synchronization with the second traveling driven wheel.

In a possible implementation of the present disclosure, the adjusting mechanism further includes a cooperating member, and the cooperating member and the first traveling driven wheel are fixedly connected to the wheel axle. The cooperating member is arranged on one of two sides of the traveling wheel, and the second traveling driven wheel is arranged on another one of the two sides of the traveling wheel. Each of the two sides of the traveling wheel is provided with a first limit surface extending in the axial direction of the wheel axle. The second traveling driven wheel is provided with a second limit surface, and the cooperating member is provided with a third limit surface. When the traveling wheel moves to the first position, the first limit surface and the second limit surface are separated from each other, and the first limit surface and the third limit surface abut against each other. When the traveling wheel moves to the second position, the first limit surface and the second limit surface abut against each other, and the first limit surface and the third limit surface are separated from each other.

In a possible implementation of the present disclosure, the traveling wheel is movable in the axial direction of the wheel axle to a third position located between the first position and the second position. When the traveling wheel moves to the third position, each of the second limit surface and the third limit surface is separated from the first limit surface.

In a possible implementation of the present disclosure, the adjusting mechanism further includes a toggle member, the toggle member is rotatably connected to the housing, and a rotation axis of the toggle member and a rotation axis of the housing are perpendicular to a central axis of the wheel axle. A first end of the toggle member close to the traveling wheel is provided with a first snap portion, the traveling wheel is provided with a second snap portion corresponding to the first snap portion, and the first snap portion and the second snap portion abut against each other. When an external force is applied to a second end of the toggle member away from the traveling wheel, the first end of the toggle member drives the traveling wheel to move to the first position, the second position, or the third position.

In a possible implementation of the present disclosure, the adjusting mechanism further includes a transition member, the transition member is slidably connected to the housing along the axial direction of the wheel axle, and the transition member is provided between the first snap portion and the second snap portion. The transition member is provided with two third snap portions disposed opposite to each other, and each of the first snap portion and the second snap portion abuts against a respective one of the two third snap portions.

In a possible implementation of the present disclosure, the scattered material cleaning robot further includes an armrest, a rope and a handle, the armrest is fixedly connected to the housing, and the handle is rotatably connected to the armrest. A first end of the rope is connected to the handle, and a second end of the rope is connected to the second end of the toggle member.

In a possible implementation of the present disclosure, the traveling wheel, the second traveling driven wheel, the toggle member, the transition member, the rope and the handle cooperating with each other form one traveling assembly, the traveling component includes two traveling assemblies, one of two traveling wheels of the two traveling assemblies is arranged at one side of the housing, and another one of the two traveling wheels of the two traveling assemblies is arranged at another side of the housing.

In a possible implementation of the present disclosure, the feeding assembly includes a connecting shaft and at least one blade fixedly connected to each other, the connecting shaft is rotatably connected to the housing, and the at least one blade helically extends in an axial direction of the connecting shaft.

In a possible implementation of the present disclosure, the connecting shaft and the first sprocket are coaxially arranged, the feeding assembly includes two blades, one of the two blades is arranged on one side of the first sprocket, another one of the two blades is arranged on another side of the first sprocket, and helical directions of the two blades are arranged opposite to each other.

### BRIEF DESCRIPTION OF THE DRAWINGS

FIG. 1 is a first schematic diagram of a scattered material cleaning robot for a conveyor according to an embodiment of the present disclosure.

FIG. 2 is a second schematic diagram of a scattered material cleaning robot for a conveyor according to an embodiment of the present disclosure.

FIG. 3 is a schematic diagram of an internal structure of a scattered material cleaning robot for a conveyor according to an embodiment of the present disclosure.

FIG. 4 is a schematic diagram of a lifting assembly of a scattered material cleaning robot for a conveyor according to an embodiment of the present disclosure.

FIG. 5 is a schematic diagram of a first sheave of a scattered material cleaning robot for a conveyor according to an embodiment of the present disclosure.

FIG. 6 is a schematic diagram of a spacer plate of a scattered material cleaning robot for a conveyor according to an embodiment of the present disclosure.

FIG. 7 is a schematic diagram of a traveling component of a scattered material cleaning robot for a conveyor according to an embodiment of the present disclosure.

FIG. 8 is an exploded diagram of a traveling component of a scattered material cleaning robot for a conveyor according to an embodiment of the present disclosure.

FIG. 9 is an exploded diagram of an adjusting mechanism of a scattered material cleaning robot for a conveyor according to an embodiment of the present disclosure.

FIG. 10 is a schematic diagram of a traveling wheel of a scattered material cleaning robot for a conveyor according to an embodiment of the present disclosure.

FIG. 11 is a schematic diagram of an adjusting mechanism of a scattered material cleaning robot for a conveyor according to an embodiment of the present disclosure.

FIG. 12 is a schematic diagram illustrating a connection of a transition member of a scattered material cleaning robot for a conveyor according to an embodiment of the present disclosure.

FIG. 13 is a schematic diagram of a transition member of a scattered material cleaning robot for a conveyor according to an embodiment of the present disclosure.

FIG. 14 is a schematic diagram illustrating a connection of an armrest and a handle of a scattered material cleaning robot for a conveyor according to an embodiment of the present disclosure.

### LIST OF REFERENCE SYMBOLS

0—conveyor belt; 1—body; 11—housing; 111—first housing; 112—second housing; 113—bucket; 114—shield; 115—spacer plate; 116—non-block groove; 117—support; 118—limit groove; 12—feeding assembly; 121—connecting shaft; 122—blade; 13—discharging assembly; 131—funnel; 132—conveying pipe; 14—traveling component; 141—wheel axle; 142—traveling wheel; 1421—first limit shaft; 1422—second limit shaft; 1423—engagement member; 1424—hub; 1425—wheel body; 1426—anti-slip protrusion; 1427—second snap portion; 143—adjusting mechanism; 1431—first traveling driven wheel; 1432—second traveling driven wheel; 1432a—second limit hole; 1433—cooperating member; 1433a—first limit hole; 1434—toggle member; 1434a—first snap portion; 1435—transition member; 1435a—third snap portion; 1436—handle; 1437—first sleeve; 1438—second sleeve; 1439—rope; 144—load wheel; 15—armrest; 2—lifting assembly; 21—flexible transmission mechanism; 21a—first transmission section; 21b—second transmission section; 211—first sprocket; 212—second sprocket; 213—annular chain; 214—auxiliary wheel; 215—first sheave; 216—second sheave; 217—non-block notch; 22—material carrying member; 3—driving assembly; 31—driving member; 32—transmission assembly; 321—lift driving wheel; 322—lift driven wheel; 323—forward driving wheel; 324—backward driving wheel; 325—annular forward flexible member; 33—gearbox.

### DETAILED DESCRIPTION

In order to make the purpose, technical solutions, and advantages of embodiments of the present disclosure more clear, specific technical solutions of the present disclosure will be further described in detail below with reference to the drawings in the embodiments of the present disclosure. The following embodiments are used to illustrate the present disclosure, but are not intended to limit the scope of the present disclosure.

In the embodiments of the present disclosure, the terms “first” and “second” are used merely for descriptive purposes, and are not to be construed as indicating or implying relative importance thereof or implicitly specifying the number of indicated technical features. Thus, the features defined as “first” and “second” may explicitly or implicitly mean that one said feature or a plurality off said features are included. In the description of the embodiments of the present disclosure, “a plurality of” means two or more than two, unless explicitly and specifically defined otherwise.

In addition, in the embodiments of the present disclosure, the orientation terms such as “upper”, “lower”, “left” and “right” are defined with respect to an orientation in which components are schematically placed in the drawings. It should be understood that these orientation terms are relative concepts, and they are used for description and clarification of relativity, and can change accordingly according to the change of the orientation in which the components are placed in the drawings.

In the embodiments of the present disclosure, unless otherwise explicitly specified and defined, the term “connect” should be understood broadly. For example, “connection” may be a fixed connection or a detachable connection or an integral connection, and may be a direct connection or an indirect connection through an intermediate medium.

In the embodiments of the present disclosure, the terms “comprising”, “including” or any other variation thereof are intended to encompass a non-exclusive inclusion such that a process, method, article, or device that includes a series of elements includes not only those elements, but also other elements that are not explicitly listed, or elements inherent to such a process, method, article, or device. Without further limitation, an element defined by the phrase “comprising a . . .” does not preclude the presence of additional identical elements in a process, method, article, or device comprising the element.

In the embodiments of the present disclosure, the wordings “exemplarily” or “for example” are used to mean an example, illustration, or description. Any embodiment or designing scheme described as “exemplarily” or “for example” in the embodiments of the present disclosure should not be construed as being more preferred or superior to other embodiments or designing schemes. Rather, the use of wording such as “exemplarily” or “for example” is intended to present related concepts in a specific manner.

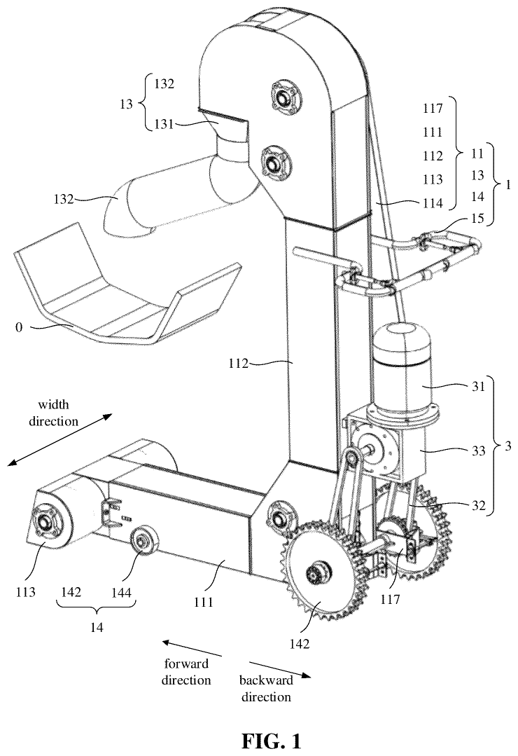

An embodiment of the present disclosure provides a scattered material cleaning robot for a conveyor, which is configured to recover scattered materials during transportation by the conveyor. The conveyor may be a belt conveyor, a screw conveyor, or the like, and any conveyor that will scatter materials during transportation of the materials can be applied to the scattered material cleaning robot for the conveyor according to the present disclosure. For convenience of description, taking a belt conveyor as an example, referring to FIG. 1, the belt conveyor includes a conveyor belt 0, materials are placed on an upper side of the conveyor belt 0, and the materials may be scattered to form scattered materials during the transportation by the conveyor belt 0.

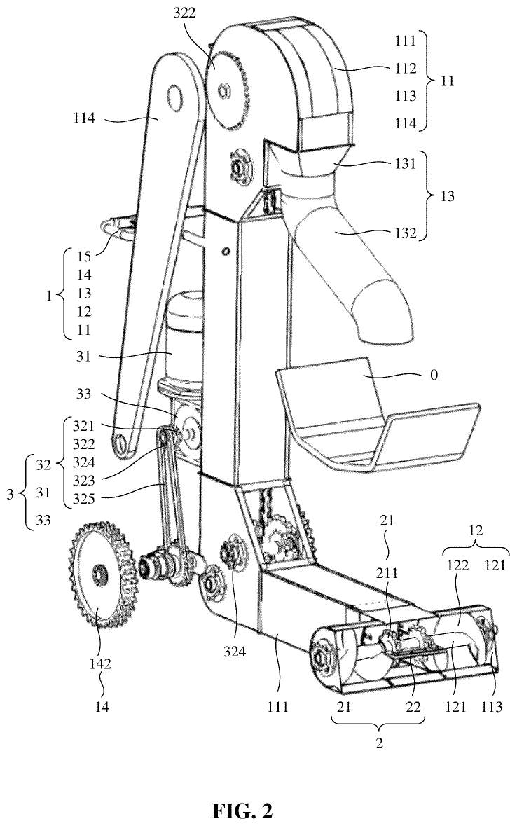

Referring to FIG. 1 and FIG. 2, the scattered material cleaning robot for the conveyor provided by the embodiment of the present disclosure includes a body 1, a lifting assembly 2, and a driving assembly 3. The body 1 is movable relative to the conveyor. The body 1 includes a housing 11, a feeding assembly 12 and a discharging assembly 13, and the feeding assembly 12 and the discharging assembly 13 are disposed on the housing 11. The feeding assembly 12 is configured to collect scattered materials, the discharging assembly 13 is disposed above the feeding assembly 12, and the discharging assembly 13 is configured to deliver the scattered materials collected by the feeding assembly 12 to the conveyor. The lifting assembly 2 is disposed in the housing 11, and the lifting assembly 2 includes a flexible transmission mechanism 21 and at least one material carrying member 22. One of two ends of the flexible transmission mechanism 21 is located at the feeding assembly 12, and another one of the two ends of the flexible transmission mechanism 21 is located at the discharging assembly 13. The flexible transmission mechanism 21 is configured to drive the material carrying member 22 to move between the feeding assembly 12 and the discharging assembly 13, to convey the scattered materials from the feeding assembly 12 to the discharging assembly 13. The driving assembly 3 is configured to drive the body 1 and the flexible transmission mechanism 21 to move.

In the scattered material cleaning robot for the conveyor provided by the embodiment of the present disclosure, the body 1 is driven through the driving assembly 3 to move relative to the conveyor, thereby moving to a position where the scattered materials are located. In this way, the robot of the present disclosure can clean the scattered materials in a wider range, and the operation range of the robot of the present disclosure is improved. One robot can clean the scattered materials at a plurality of different positions, and compared with a situation that each scattered material position is provided with one cleaning mechanism, the robot of the present disclosure is more economical and can reduce the occupation of space around the conveyor by the cleaning mechanism.

Specifically, the body 1 includes a housing 11, a feeding assembly 12 and a discharging assembly 13, and the feeding assembly 12 and the discharging assembly 13 are disposed on the housing 11. The feeding assembly 12 is configured to collect scattered materials, the discharging assembly 13 is disposed above the feeding assembly 12, and the discharging assembly 13 is configured to deliver the scattered materials collected by the feeding assembly 12 to the conveyor.

In addition, the robot of the present disclosure is further provided with a lifting assembly 2 in the housing 11, to convey the scattered materials collected by the feeding assembly 12 to the discharging assembly 13. Specifically, the lifting assembly 2 includes a flexible transmission mechanism 21 and at least one material carrying member 22. The material carrying member 22 is configured to carry the scattered materials. One of two ends of the flexible transmission mechanism 21 is located at the feeding assembly 12, and another one of the two ends of the flexible transmission mechanism 21 is located at the discharging assembly 13. The driving assembly 3 is configured to drive the flexible transmission mechanism 21. The flexible transmission mechanism 21 is configured to drive the material carrying member 22 to move between the feeding assembly 12 and the discharging assembly 13, to convey the scattered materials from the feeding assembly 12 to the discharging assembly 13.

Due to the arrangement of the lifting assembly 2, the scattered materials can be conveyed from a lower position to a higher position, to allow the feeding assembly 12 to be disposed at any height below the conveyor belt 0 for collecting the scattered materials. For example, the feeding assembly 12 is disposed on the ground, and the scattered materials on the ground are collected by the feeding assembly 12 and then are conveyed to the discharging assembly 13 through the lifting assembly 2.

It should be noted that the wordings such as “below” and “above” in the present disclosure are only used to describe a height relationship between two objects relative to the ground, and unless otherwise specified, they do not specifically refer to the alignment of the two objects in a vertical direction.

Compared with the scheme in a related art in which the cleaning mechanism is immobilized relative to the conveyor and can only clean the scattered materials contaminated on the conveyor belt 0, the robot of the present disclosure is movable, and thus has a larger operation range, and due to the arrangement of the lifting assembly 2, the scattered materials can be conveyed from a lower position to a higher position, to allow the robot to clean and recover the scattered materials below the conveyor belt 0, such as the scattered materials on the ground.

The housing 11 provides an installation foundation for other components, and the housing 11 has a plurality of possible forms. The housing 11 may be a closed structure or an open structure, and the shape of the housing 11 may be a square block shape, a cylindrical shape, a frustum of a square pyramid, or the like, which is not limited in the present disclosure.

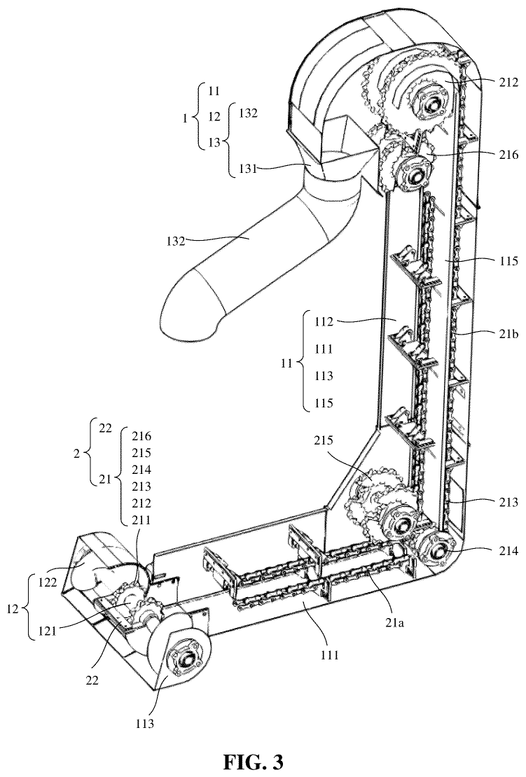

Referring to FIG. 1, FIG. 2 and FIG. 3, in a possible implementation of the present disclosure, the housing 11 includes a first housing 111 and a second housing 112 fixedly connected to each other and communicating with each other. The first housing 111 is horizontally arranged relative to the ground, and the second housing 112 is vertically arranged relative to the ground. Each of a cross section of the first housing 111 and a cross section of the second housing 112 is roughly rectangular. An end of the first housing 111 away from the second housing 112 is provided with a feeding port, the feeding port is vertically arranged relative to the ground, and the feeding assembly 12 is arranged at the feeding port. The first housing 111 can extend into the space below the conveyor belt 0 in case that the housing 11 does not collide with the conveyor, to allow the scattered materials located in a narrow space to be cleaned.

An end of the second housing 112 away from the first housing 111 is provided with a discharging port. The second housing 112 mainly corresponds to an ascending movement of the scattered materials, and a vertical arrangement of the second housing 112 can reduce the space occupation of the housing 11 along a horizontal direction, which leads to a more compact robot. The discharging port is horizontally arranged relative to the ground, and the discharging assembly 13 is arranged at the discharging port.

In order to facilitate feeding, referring to FIG. 2 and FIG. 3, an end of the first housing 111 away from the second housing 112 is provided with a bucket 113. When the body moves in a forward direction, the scattered materials can be shoveled into the bucket 113. The interior of the bucket 113 communicates with the first housing 111 through the feeding port. Optionally, a dimension of the bucket 113 in a width direction of the body 1 is greater than a dimension of the first housing 111 in the width direction, which improves the efficiency of shoveling the scattered materials.

Furthermore, the feeding assembly 12 has a variety of possible forms. For example, the feeding assembly 12 includes a scraper configured to swing to scrape the scattered materials into the feeding port. As another example, the feeding assembly 12 includes a brush configured to brush the scattered materials into the feeding port through a rotary movement or an oscillation of the brush.

Referring to FIG. 2 and FIG. 3, in a possible implementation of the present disclosure, the feeding assembly 12 includes a connecting shaft 121 and a blade 122 fixedly connected to each other, and the connecting shaft 121 is rotatably connected to the housing 11. Specifically, the connecting shaft 121 and the blade 122 are located in the bucket 113, and the connecting shaft 121 is arranged in the width direction of the body 1 and is rotatably connected to the bucket 113. In addition, the connecting shaft 121 is connected to the driving assembly 3 for transmission, and the blade 122 helically extends in an axial direction of the connecting shaft 121. The driving assembly 3 drives the connecting shaft 121 to rotate, the connecting shaft 121 drives the blade 122 to rotate, and the blade 122 gradually gather the scattered materials through a spiral movement thereof.

Correspondingly, the discharging assembly 13 also has a variety of possible forms. For example, the discharging assembly 13 is an air blowing member, and the scattered materials are blown to the conveyor belt 0 of the conveyor through an air flow. As another example, the discharging assembly 13 includes a scraper configured to scrape the scattered materials from the material carrying member 22 to the conveyor belt 0.

Referring to FIG. 1, FIG. 2 and FIG. 3, in a possible implementation of the present disclosure, the discharging assembly 13 includes a funnel 131 disposed at the discharging port, the funnel 131 is fixed to the housing 11, an outlet of the funnel 131 is fixedly connected to a conveying pipe 132, and the conveying pipe 132 extends above the feeding assembly 12. That is, an outlet of the conveying pipe 132 and the feeding assembly 12 are roughly aligned with each other in the vertical direction, the conveying pipe 132 is located above the conveyor belt 0, and the scattered materials fall onto the conveyor belt 0 by gravity.

It should be noted that the driving assembly 3 has a variety of possible forms. For example, the driving assembly 3 includes a driving member 31 and a transmission assembly 32. The driving member 31 may be a hydraulic cylinder, a motor, a rotary cylinder, or the like, and the transmission assembly 32 may be a pinion and rack assembly, a gear assembly, a worm gear assembly, a pulley assembly, a sprocket assembly, or the like, which is not limited in the present disclosure. Optionally, the driving assembly also may include a gearbox 33 or the like.

Referring to FIG. 1 and FIG. 2, in a possible implementation of the present disclosure, the driving assembly 3 includes a gearbox 33, a driving member 31, and a transmission assembly 32. The gearbox 33 is fixed to a vertical side of the second housing 112, and the gearbox 33 is located on a side face of the second housing 112 away from the first housing 111. The driving member 31 is fixed to an upper surface of the gearbox 33, and is a motor. An output shaft of the driving member 31 is vertically arranged, the driving member 31 is connected to the gearbox 33 for transmission, and an output shaft of the gearbox 33 is horizontally arranged and is perpendicular to a forward direction or a backward direction of the body 1. The output shaft of the gearbox 33 is connected to the body 1 and the flexible transmission mechanism 21 through a transmission connection.

In order to improve the stability of the robot of the present disclosure, optionally, the gearbox 33 and the motor are provided below a center of gravity of the second housing 112, which lowers a center of gravity of the robot of the present disclosure to improve the stability of the robot.

It should be noted that the flexible transmission mechanism 21 may be a belt transmission mechanism, a chain transmission mechanism, a rope transmission mechanism, or the like, which is not limited in the present disclosure.

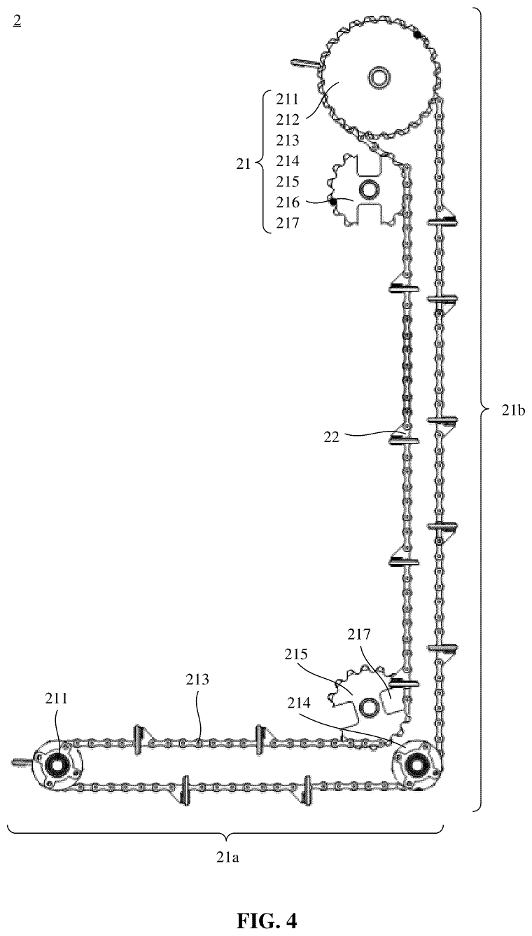

Referring to FIG. 3 and FIG. 4, in a possible implementation of the present disclosure, the flexible transmission mechanism 21 is a chain transmission mechanism. Specifically, the flexible transmission mechanism 21 includes a first sprocket 211, a second sprocket 212, and an annular chain 213. For ease of understanding, a portion of the annular chain 213 and the housing 11 are hidden in the figure. Each of the first sprocket 211 and the second sprocket 212 is rotatably connected to the housing 11. One of the first sprocket 211 and the second sprocket 212 is connected to the driving assembly 3 for transmission and serves as a driving sprocket, and another one of the first sprocket 211 and the second sprocket 212 serves as a driven sprocket. The first sprocket 211 is located at the feeding assembly 12, and the second sprocket 212 is located at the discharging assembly 13. One of two ends of the annular chain 213 is wrapped around the first sprocket 211, and another one of the two ends of the annular chain 213 is wrapped around the second sprocket 212. The material carrying member 22 is fixed to an outer side of the annular chain 213.

Optionally, in the flexible transmission mechanism 21, the first sprocket 211 is a driving sprocket, the second sprocket 212 is a driven sprocket, and the first sprocket 211 is connected to the driving assembly 3 for transmission. Referring to FIG. 2, the transmission assembly 32 includes a lift driving wheel 321, a lift driven wheel 322, and an annular lift flexible member (not shown). The lift driving wheel 321 and the first sprocket 211 are coaxially fixed, and the lift driving wheel 321 is located outside the housing 11. The lift driven wheel 322 is fixed to the output shaft of the gearbox 33. One of two ends of the annular lift flexible member is wrapped around the lift driving wheel 321, and another one of the two ends of the annular lift flexible member is wrapped around the lift driven wheel 322.

A radial dimension of the lift driven wheel 322 may be greater than a radial dimension of the lift driving wheel 321, to further reduce the speed and improve the stability of the operation of the flexible transmission mechanism 21. Furthermore, the housing 11 further includes a shield 114 fixed to the second housing 112, and the lift driving wheel 321, the lift driven wheel 322, and the annular lift flexible member are arranged in the shield 114.

In addition, in order to simplify the structure, referring to FIG. 2 and FIG. 3, the connecting shaft 121 of the feeding assembly 12 and the first sprocket 211 are coaxially arranged. That is, the driving assembly 3 drives the feeding assembly 12 to move through the flexible transmission mechanism 21. There are two blades 122, one of the two blades 122 is arranged on one side of the first sprocket 211 and another one of the two blades 122 is arranged on another side of the first sprocket 211, and the first sprocket 211 is located at a middle position of the bucket 113. The helical directions of the two blades 122 are arranged opposite to each other, and when the two blades 122 rotate with the rotation of the first sprocket 211, the scattered materials can be gathered toward an intermediate position between the two blades 122.

It should be noted that the material carrying member 22 has a variety of possible implementations. For example, the material carrying member 22 has a plate shape, a bucket shape, or the like. Referring to FIG. 3 and FIG. 4, in a possible implementation of the present disclosure, the material carrying member 22 has a square plate shape, the material carrying member 22 is arranged perpendicularly to an outer surface of the annular chain 213, and a side of the material carrying member 22 away from the annular chain 213 approximately fits an inner wall of the housing 11, to reduce the possibility that materials are scattered from the material carrying member 22 during transportation.

The increase of the number of the material carrying member 22 can improve a conveying efficiency of the lifting assembly. Optionally, there are a total of twenty material carrying members 22, the annular chain 213 includes 160 sections, and one material carrying member 22 is installed every eight sections of the annular chain 213. In this way, the lifting assembly can efficiently convey the scattered materials.

In order to adapt the flexible transmission mechanism 21 to the shape of the housing 11, referring to FIG. 3 and FIG. 4, in a possible implementation of the present disclosure, the flexible transmission mechanism 21 further includes an auxiliary wheel 214 and a first sheave 215, and each of the auxiliary wheel 214 and the first sheave 215 abuts against a respective one of an inner side and an outer side of the annular chain 213 in the same direction, to allow the flexible transmission mechanism 21 to form a first transmission section 21a and a second transmission section 21b.

The first transmission section 21a is arranged horizontally and includes the first sprocket 211. That is, the first transmission section 21a is arranged inside the first housing 111. A preset angle is formed between the second transmission section 21b and the first transmission section 21a. Specifically, the preset angle ranges from 85 ° to 95 °. For example, the first transmission section 21a and the second transmission section 21b are arranged perpendicular to each other. The second transmission section 21b includes the second sprocket 212, that is, the second transmission section 21b is arranged inside the second housing 112.

It should be noted that in the present disclosure, the horizontal arrangement of the first housing 111 and the first transmission section 21a is approximately horizontal, and an angle between the first housing 111 and the ground may be in a range of 0 to 5 °. The same is true for the first transmission section 21a, and it is only necessary to ensure that the bucket 113 can shovel the scattered materials.

In order to make the scattered materials easier to fall into the funnel 131 through the discharging port, referring to FIG. 3 and FIG. 4, in a possible implementation of the present disclosure, the flexible transmission mechanism 21 further includes a second sheave 216 abutting against an outer side of the second transmission section 21b, to allow the annular chain 213 to form a recess below the second sprocket 212, and the discharging assembly 13 is arranged at the recess. In this way, the funnel 131 can be arranged closer to the material carrying member 22, and an interference of the material carrying member 22 with the discharging assembly 13 during the movement of the material carrying member 22 is avoided. Optionally, a projection of the second sprocket 212 in the vertical direction at least partially overlaps with a projection of the discharging assembly 13 in the vertical direction.

Since the first sheave 215, the second sheave 216, and the material carrying member 22 are located on an outer side of the annular chain 213, in order to avoid an interference between the first sheave 215 and the material carrying member 22 as well as an interference between the second sheave 216 and the material carrying member 22, each of the first sheave 215 and the second sheave 216 may be provided with a non-block notch 217, or the material carrying member 22 may be provided with a non-block notch 217.

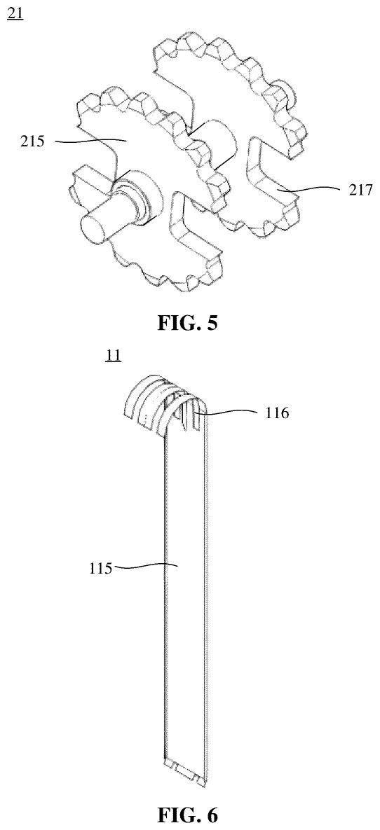

In order to improve the integrity of the material carrying member 22 and improve the carrying capacity thereof, referring to FIG. 4 and FIG. 5, in a possible implementation of the present disclosure, a circumferential side of the first sheave 215 is provided with at least one first non-block notch 217, a circumferential side of the second sheave 216 is provided with at least one second non-block notch 217, and each of the first non-block notch 217 and the second non-block notch 217 is configured to unblock the material carrying member 22.

Optionally, the first sheave 215 and the second sheave 216 are similar in terms of the structure. The circumferential side of the first sheave 215 is provided with two first non-block notches 217, the two first non-block notches 217 are arranged opposite to each other, and a spacing between the two first non-block notches 217 along a circumferential direction of the first sheave 215 is consistent with a spacing between two adjacent material carrying members 22 arranged on the annular chain 213. The circumferential side of the second sheave 216 is provided with two second non-block notches 217, the two second non-block notches 217 are arranged opposite to each other, and a spacing between the two second non-block notches 217 along a circumferential direction of the second sheave 216 is consistent with a spacing between two adjacent material carrying members 22 arranged on the annular chain 213.

In addition, the second housing 112 is provided with openings each corresponding to the first sheave 215 and the second sheave 216, to facilitate the maintenance of the flexible transmission mechanism 21.

It should be noted that each of the first sprocket 211, the second sprocket 212, the auxiliary wheel 214, the first sheave 215, and the second sheave 216 may be a single-row wheel, double-row wheels, or multi-row wheels. Referring to FIG. 3 and FIG. 5, in a possible implementation of the present disclosure, each of the first sprocket 211, the second sprocket 212, the auxiliary wheel 214, the first sheave 215, and the second sheave 216 is double-row wheels, that is, coaxial double-coupled wheels, and two annular chains 213 are provided correspondingly.

In an example, each of the first sprocket 211 and the second sprocket 212 is provided with 24 teeth, each of the first sheave 215 and the second sheave 216 is provided with 16 teeth, and the auxiliary wheel 214 is provided with 7 teeth.

In addition, in order to avoid a mutual interference among the flexible transmission mechanism 21, the ascending side and the descending side, referring to FIG. 3 and FIG. 6, the robot of the present disclosure further includes a spacer plate 115 fixed to the housing 11, the spacer plate 115 is arranged on an inner side of the second transmission section 21b, and the spacer plate 115 extends along a profile of the annular chain 213.

Specifically, a lower portion of the spacer plate 115 is vertically disposed corresponding to the second housing 112, an upper end of the spacer plate 115 is bent into a semicircular structure, and a central axis of the semicircular structure is coaxially arranged with the second sprocket 212. The semicircular structure is also provided with a non-block groove 116 corresponding to the second sprocket 212, and the non-block groove 116 is configured to unblock the second sprocket 212.

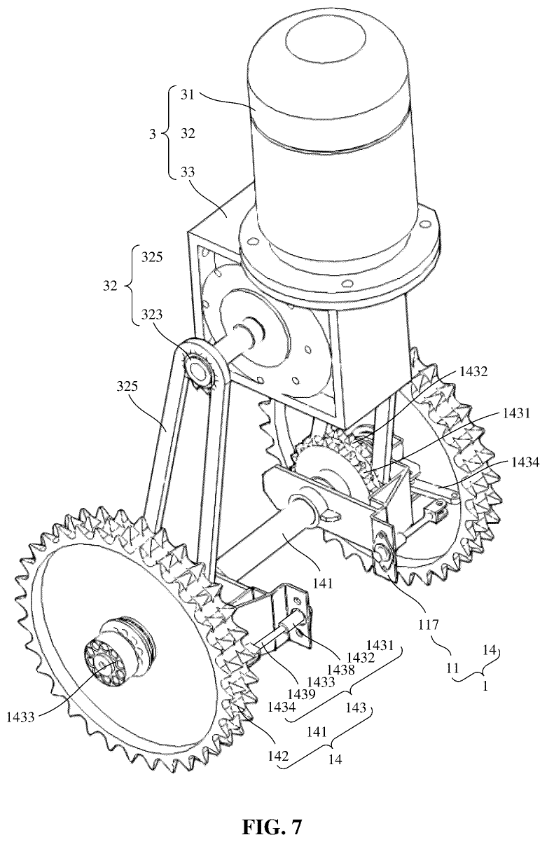

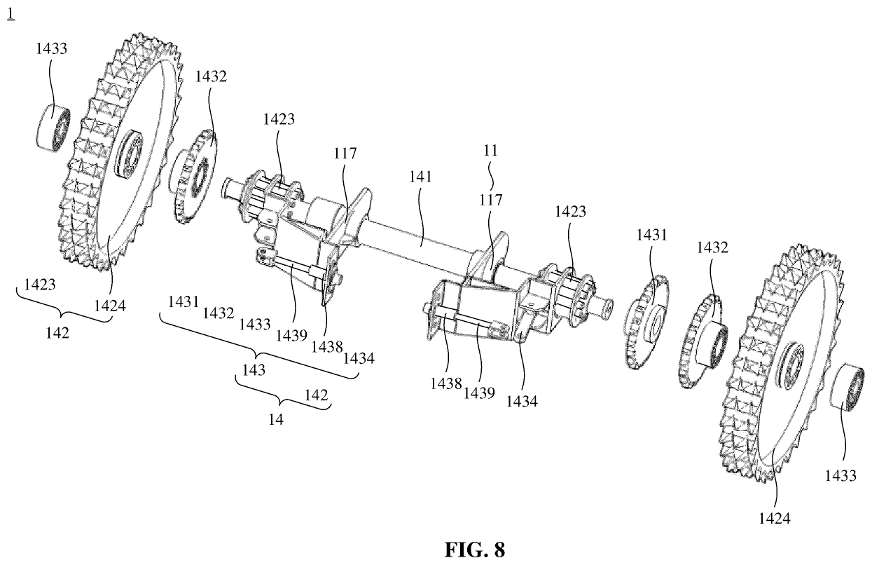

In order to facilitate the movement of the robot of the present disclosure, referring to FIG. 1, FIG. 7 and FIG. 8, the body 1 further includes a traveling component 14, the traveling component 14 includes a wheel axle 141, a traveling wheel 142, and an adjusting mechanism 143, and the wheel axle 141 is rotatably connected to the housing 11. Optionally, the wheel axle 141 is connected to a lower portion of the second housing 112. The traveling wheel 142 is rotatably connected to the wheel axle 141, and the traveling wheel 142 is movable in an axial direction of the wheel axle 141 to a first position and a second position. The adjusting mechanism 143 includes a first traveling driven wheel 1431 and a second traveling driven wheel 1432 arranged around the wheel axle 141. Each of the first traveling driven wheel 1431 and the second traveling driven wheel 1432 is connected to the driving assembly 3 for transmission, and a rotation direction of the first traveling driven wheel 1431 is opposite to a rotation direction of the second traveling driven wheel 1432. When the traveling wheel 142 moves to the first position, the traveling wheel 142 rotates in synchronization with the first traveling driven wheel 1431. When the traveling wheel 142 moves to the second position, the traveling wheel 142 rotates in synchronization with the second traveling driven wheel 1432.

Optionally, the first traveling driven wheel 1431 drives the traveling wheel 142 to rotate forward, to drive the body 1 to move in the forward direction, and the second traveling driven wheel 1432 drives the traveling wheel 142 to rotate backward, to drive the body 1 to move in the backward direction. Alternatively, the second traveling driven wheel 1432 drives the traveling wheel 142 to rotate forward, to drive the body 1 to move in the forward direction, and the first traveling driven wheel 1431 drives the traveling wheel 142 to rotate backward, to drive the body 1 to move in the backward direction, which is not limited in the present disclosure. The transmission mode of the first traveling driven wheel 1431, the second traveling driven wheel 1432, and the driving assembly 3 can be achieved through a gear transmission, a belt transmission, a chain transmission, or the like.

Referring to FIG. 2 and FIG. 7, in a possible implementation of the present disclosure, the transmission assembly 32 includes a forward driving wheel 323, a backward driving wheel 324, an annular forward flexible member 325, and an annular backward flexible member (not shown). The forward driving wheel 323 is fixed to the output shaft of the gearbox 33. One of two ends of the annular forward flexible member 325 is wrapped around the forward driving wheel 323, and another one of the two ends of the annular forward flexible member 325 is wrapped around the second traveling driven wheel 1432. The backward driving wheel 324 and the first sheave 215 are coaxially fixed. One of two ends of the annular backward flexible member is wrapped around the backward driving wheel 324, and another one of the two ends of the annular backward flexible member is wrapped around the first traveling driven wheel 1431.

It should be noted that each of the lift driving wheel 321, the lift driven wheel 322, the forward driving wheel 323, the backward driving wheel 324, the first traveling driven wheel 1431, and the second traveling driven wheel 1432 may be a sprocket, a pulley, or the like, and each of the annular lift flexible member, the annular forward flexible member 325, and the annular backward flexible member may be a chain, a transmission belt, or the like. The present disclosure is not limited thereto as long as the transmission is ensured.

Furthermore, in order to facilitate fixation of the wheel axle 141, referring to FIG. 7 and FIG. 8, the housing 11 is provided with a support 117 on each of two sides in the width direction of the body 1, and the two supports 117 are fixed to the second housing 112. Each of two ends of the wheel axle 141 penetrates through a respective one of the two supports 117, and the wheel axle 141 and the two supports 117 are rotatably connected to each other.

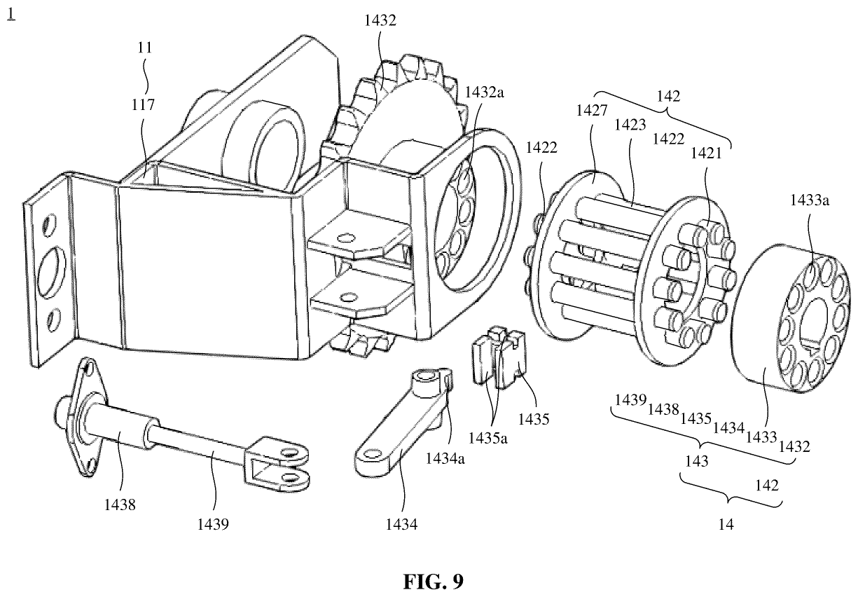

In order to facilitate the synchronous rotation of the traveling wheel 142 with the first traveling driven wheel 1431 and the second traveling driven wheel 1432, referring to FIG. 8 and FIG. 9, in a possible implementation of the present disclosure, the adjusting mechanism 143 further includes a cooperating member 1433, and the cooperating member 1433 and the first traveling driven wheel 1431 are fixedly connected to the wheel axle 141. The cooperating member 1433 is arranged on one of two sides of the traveling wheel 142 and the second traveling driven wheel 1432 is arranged on another one of the two sides of the traveling wheel 142. Specifically, the cooperating member 1433 is located on a side of the traveling wheel 142 away from the support 117, and the second traveling driven wheel 1432 is located on a side of the traveling wheel 142 close to the support 117.

A first limit shaft 1421 protrudes from a side of the traveling wheel 142 toward the cooperating member 1433. A second limit shaft 1422 protrudes from a side of the traveling wheel 142 toward the second traveling driven wheel 1432. Each of the first limit shaft 1421 and the second limit shaft 1422 is provided with a first limit surface extending in an axial direction of the wheel axle 141. A side of the cooperating member 1433 toward the traveling wheel 142 is provided with a first limit hole 1433a. The first limit hole 1433a is provided with a third limit surface extending in the axial direction of the wheel axle 141. A side of the second traveling driven wheel 1432 toward the traveling wheel 142 is provided with a second limit hole 1432a. The second limit hole 1432a is provided with a second limit surface extending in the axial direction of the wheel axle 141.

When the traveling wheel 142 moves to the first position, the second limit shaft 1422 withdraws from the second limit hole 1432a, the first limit surface and the second limit surface are separated from each other, the first limit shaft 1421 extends into the first limit hole 1433a, the first limit surface and the third limit surface abut against each other, and the traveling wheel 142, the cooperating member 1433 and the first traveling driven wheel 1431 rotate synchronously, to drive the body to move in the backward direction.

When the traveling wheel 142 moves to the second position, the second limit shaft 1422 extends into the second limit hole 1432a, the first limit surface and the second limit surface abut against each other, the first limit shaft 1421 withdraws from the first limit hole 1433a, the first limit surface and the third limit surface are separated from each other, and the traveling wheel 142 and the second traveling driven wheel 1432 rotate synchronously, to drive the body to move in the forward direction.

It should be noted that each of the limit holes (including the first limit hole 1433a and the second limit hole 1432a) may be provided on a respective one of two sides of the traveling wheel 142, and each of the limit shafts (including the first limit shaft 1421 and the second limit shaft 1422) may be provided on a respective one of the second traveling driven wheel 1432 and the cooperating member 1433. A radial dimension of the limit hole can be consistent with a radial dimension of the limit shaft, or a radial dimension of the limit hole can be slightly greater than a radial dimension of the limit shaft, to allow the limit shaft to be inserted into the limit hole.

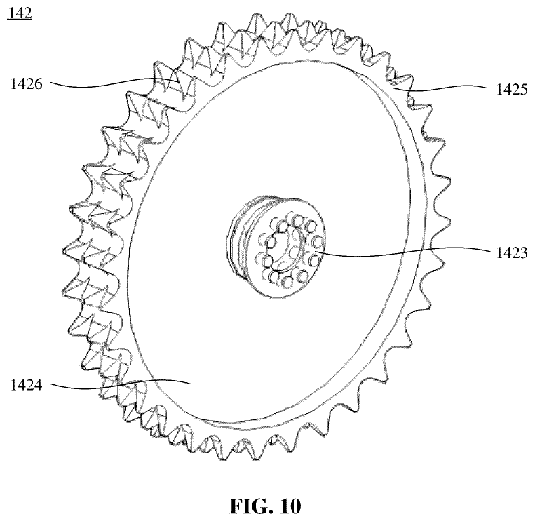

Optionally, referring to FIG. 10, the traveling wheel 142 includes an engagement member 1423, a hub 1424, and a wheel body 1425. The engagement member 1423 is rotatably connected to the wheel axle 141. The limit shaft or the limit hole is provided on the engagement member 1423. The hub 1424 is fixed to an outer peripheral side of the engagement member 1423, and the wheel body 1425 is fixed to an outer peripheral side of the hub 1424. The wheel body 1425 can be made of a steel material, which has good impact resistance and wear resistance and long service life. The wheel body 1425 may also be made of a material such as rubber, which has good slip resistance and has a cushioning and shock absorbing effect. An outer peripheral side of the wheel body 1425 may be provided with an anti-slip protrusion 1426, to increase a frictional force between the traveling wheel 142 and the ground.

Furthermore, the traveling wheel 142 is also movable in the axial direction of the wheel axle 141 to a third position located between the first position and the second position. When the traveling wheel 142 moves to the third position, the first limit shaft 1421 and the first limit hole 1433a are separated from each other, and the second limit shaft 1422 and the second limit hole 1432a are separated from each other, that is, each of the second limit surface and the third limit surface is separated from the first limit surface. At this time, the body stops relative to the ground, and does not move in the forward direction and in the backward direction.

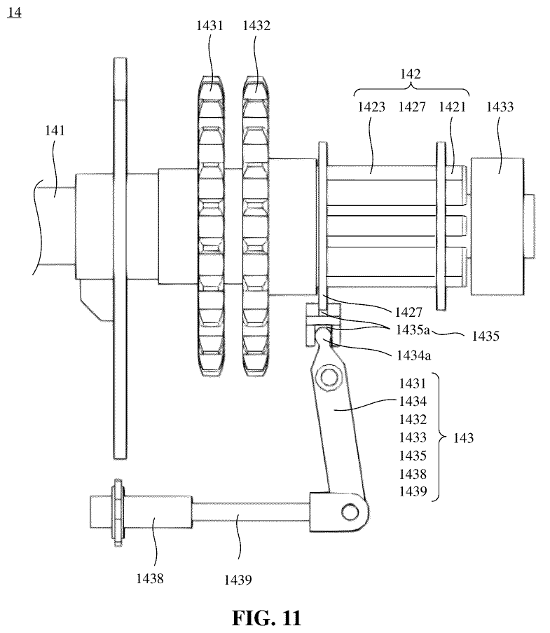

In order to facilitate the movement of the traveling wheel 142 along the wheel axle 141, referring to FIG. 9 and FIG. 11, in a possible implementation of the present disclosure, the adjusting mechanism 143 further includes a toggle member 1434, and the toggle member 1434 is rotatably connected to the housing 11. Specifically, the toggle member 1434 is rotatably connected to the support 117. A rotation axis of the toggle member 1434 and a rotation axis of the housing 11 are perpendicular to a central axis of the wheel axle 141. A first end of the toggle member 1434 close to the traveling wheel 142 is provided with a first snap portion 1434a, and the traveling wheel 142 is provided with a second snap portion 1427 corresponding to the first snap portion 1434a. Specifically, the second snap portion 1427 is provided on the engagement member 1423. The first snap portion 1434a and the second snap portion 1427 abut against each other. When an external force is applied to a second end of the toggle member 1434 away from the traveling wheel 142, the first end of the toggle member 1434 may drive the traveling wheel 142 to move to the first position, the second position, or the third position.

The first snap portion 1434a and the second snap portion 1427 may directly abut against each other. In an example, the first snap portion 1434a is a slot, the second snap portion 1427 is a bump, and the second snap portion 1427 extends into the first snap portion 1434a to abut against the first snap portion 1434a. Alternatively, the first snap portion 1434a is a bump, the second snap portion 1427 is a slot, and the first snap portion 1434a extends into the second snap portion 1427 to abut against the second snap portion 1427.

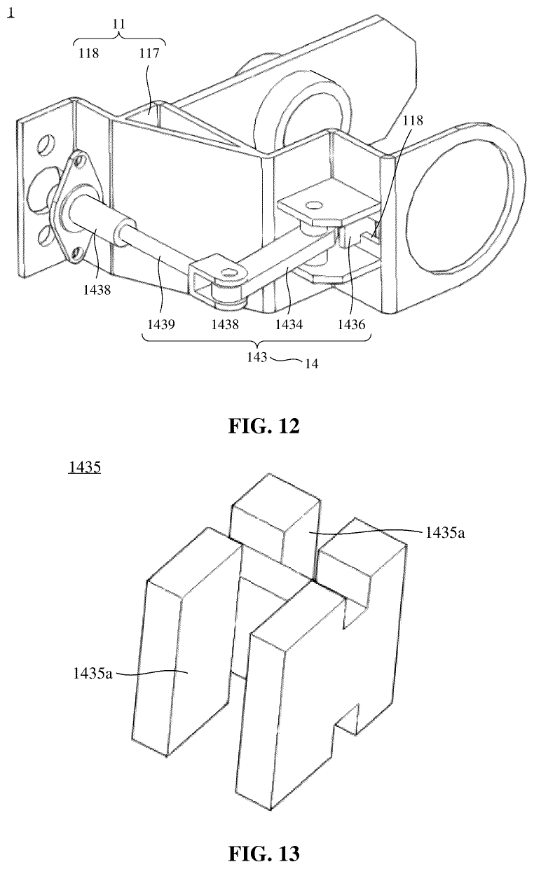

Optionally, the first snap portion 1434a and the second snap portion 1427 indirectly abut against each other. Referring to FIG. 9, FIG. 11 and FIG. 12, in a possible implementation of the present disclosure, the adjusting mechanism 143 further includes a transition member 1435, the transition member 1435 is slidably connected to the housing 11 along the axial direction of the wheel axle 141, and the transition member 1435 is provided between the first snap portion 1434a and the second snap portion 1427. Referring to FIG. 13, the transition member 1435 is provided with two third snap portions 1435a disposed opposite to each other, and each of the first snap portion 1434a and the second snap portion 1427 abuts against a respective one of the two third snap portions 1435a.

Specifically, the support 117 of the housing 11 is provided with a limit groove 118 corresponding to the transition member 1435, the transition member 1435 is arranged in the limit groove 118, and the transition member 1435 is slidably connected to the support 117. Each of the two third snap portions 1435a is a slot, each of the first snap portion 1434a and the second snap portion 1427 is a bump, and each of the first snap portion 1434a and the second snap portion 1427 extends into a respective one of the two third snap portions 1435a. Alternatively, each of the third snap portions 1435a may be a bump. By providing the transition member 1435, the toggle member 1434 and the engagement member 1423 can be maintained in a state of abutting against each other, to prevent the second snap portion 1427 from being separated from the first snap portion 1434a as the engagement member 1423 rotates.

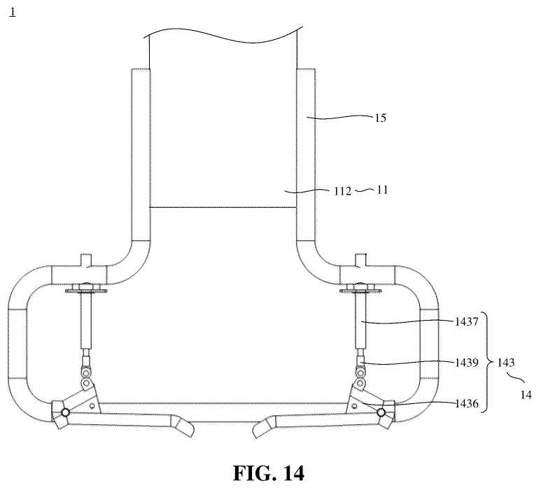

Furthermore, in order to facilitate the control of the movement of the body 1, referring to FIG. 14, the body 1 further includes an armrest 15, a rope 1439 (not shown in the figure), and a handle 1436. The armrest 15 is fixedly connected to the housing 11. Specifically, the armrest 15 is fixedly connected to a side of the second housing 112 away from the first housing 111. The handle 1436 is rotatably connected to the armrest 15. Specifically, a rotation axis of the handle 1436 and a rotation axis of the armrest 15 are arranged in the vertical direction. The rope 1439 may be a steel wire rope or the like. A first end of the rope 1439 is connected to the handle 1436, and a second end of the rope 1439 is connected to a second end of the toggle member 1434.

Specifically, a first sleeve 1437 and a second sleeve 1438 are arranged around two ends of the rope 1439. The first sleeve 1437 is fixed to the armrest 15, and a central axis of the first sleeve 1437 is arranged perpendicular to the rotation axis of the handle 1436 and the rotation axis of the armrest 15. The first end of the rope 1439 penetrates through the first sleeve 1437 and is hinged to the handle 1436. The second sleeve 1438 is fixed to the housing 11, and a central axis of the second sleeve 1438 is arranged perpendicular to a rotation axis of the toggle member 1434 and a rotation axis of the housing 11. The second end of the rope 1439 penetrates through the second sleeve 1438 and is hinged to the second end of the toggle member 1434. The second end of the rope 1439 has a corresponding stiffness, for example, the second end of the rope 1439 is a stiff bar. In this way, the second end of the rope 1439 can either pull or push the toggle member 1434 to urge it to rotate.

When the user moves the handle 1436 away from the second housing 112, the handle 1436 drives the rope 1439, the rope 1439 drives the second end of the toggle member 1434, the toggle member 1434 rotates relative to the support 117, and the first end of the toggle member 1434 abuts against the engagement member 1423 through the transition member 1435, to urge the traveling wheel 142 to move toward the first position. When the traveling wheel 142 is located in the first position, the traveling wheel 142 is fixed to the cooperating member 1433, and the body 1 is switched to be in a state of moving in the backward direction. In contrary, when the user toggles the handle 1436 toward the second housing 112, the body 1 is switched to be in a state of moving in the forward direction. When the handle 1436 is located in an intermediate position, the body 1 stops moving.

In order to facilitate the return of the rope 1439, an elastic element (not shown) may also be provided. The elastic element may be provided between the rope 1439 and the first sleeve 1437 as well as between the rope 1439 and the second sleeve 1438, or the elastic element may also be provided between the handle 1436 and the armrest 15 as well as between the toggle member 1434 and the support, and the like. In this way, when the user does not apply a force to the handle 1436, the handle 1436 can be returned to the intermediate position, to urge the body 1 to stop moving, which can improve safety.

It should be noted that the traveling wheel 142, the second traveling driven wheel 1432, the toggle member 1434, the transition member 1435, the rope 1439, the handle 1436, the first sleeve 1437 and the second sleeve 1438 cooperating with each other form one traveling assembly. The traveling component 14 includes two traveling assemblies, one of two traveling wheels 142 of the two traveling assemblies is arranged at one side of the housing 11, and another one of the two traveling wheels 142 of the two traveling assemblies is arranged at another side of the housing 11.

Specifically, referring to FIG. 1 and FIG. 2, each of two sides of the gearbox 33 is provided with an output shaft, and each of the two output shafts of the gearbox 33 is connected to a respective one of the two second traveling driven wheels 1432 for transmission, to drive the two traveling wheels 142 to rotate forward, and each of two ends of the wheel axle 141 is fixed to a respective one of the two cooperating members 1433, to drive the two traveling wheels 142 to rotate backward.

With this arrangement, the two traveling wheels 142 not only improve the stability of supporting the body 1, but also enable differential steering. For example, when one traveling wheel 142 rotates forward and another traveling wheel 142 rotates backward at the same speed, the body 1 is driven to steer in place.

In addition, in order to facilitate the movement of the body 1 and reduce the friction between the first housing 111 and the ground, referring to FIG. 1, two load wheels 144 are provided on two sides of the first housing 111, and the two load wheels 144 and the two traveling wheels 142 cooperate with each other to support the housing 11 and related components.

The serial numbers of the embodiments of the present disclosure described above are for description only, and do not represent the advantages and disadvantages of the embodiments. What described are merely preferable embodiments of the present disclosure, and are not intended to limit the scope of protection of the present disclosure. All equivalent structures or equivalent flow transformation made using the specification and accompanying drawings of the present disclosure, or direct or indirect applications of the application to other related technical fields should be included within the scope of protection of the present disclosure.

### INDUSTRIAL PRACTICALITY

In the scattered material cleaning robot for the conveyor provided by the embodiment of the present disclosure, the body is movable relative to the conveyor, thereby moving to a position where the scattered materials are located. In this way, the robot of the present disclosure can clean the scattered materials in a wider range, and the operation range of the robot of the present disclosure is improved. One robot can clean the scattered materials at a plurality of different positions, and compared with a situation that each scattered material position is provided with one cleaning mechanism, the robot of the present disclosure is more economical and can reduce the occupation of space around the conveyor by the cleaning mechanism.

1. A scattered material cleaning robot for a conveyor, comprising:
a body, the body being movable relative to the conveyor, the body comprising a housing, a feeding assembly and a discharging assembly, the feeding assembly and the discharging assembly being disposed on the housing, the feeding assembly being configured to collect scattered materials, the discharging assembly being disposed above the feeding assembly, the discharging assembly being configured to deliver the scattered materials collected by the feeding assembly to the conveyor;
a lifting assembly, the lifting assembly being disposed in the housing, the lifting assembly comprising a flexible transmission mechanism and at least one material carrying member, one of two ends of the flexible transmission mechanism being located at the feeding assembly, another one of the two ends of the flexible transmission mechanism being located at the discharging assembly, the flexible transmission mechanism being configured to drive the at least one material carrying member to move between the feeding assembly and the discharging assembly, to convey the scattered materials from the feeding assembly to the discharging assembly; and
a driving assembly, the driving assembly being configured to drive the body and the flexible transmission mechanism to move.

2. The scattered material cleaning robot for the conveyor according to claim 1, wherein the flexible transmission mechanism comprises a first sprocket, a second sprocket and an annular chain, each of the first sprocket and the second sprocket being rotatably connected to the housing, one of the first sprocket and the second sprocket being connected to the driving assembly for transmission, the first sprocket being located at the feeding assembly, the second sprocket being located at the discharging assembly, one of two ends of the annular chain being wrapped around the first sprocket, another one of the two ends of the annular chain being wrapped around the second sprocket, the at least one material carrying member being fixed to an outer side of the annular chain.

3. The scattered material cleaning robot for the conveyor according to claim 2, wherein the flexible transmission mechanism further comprises an auxiliary wheel and a first sheave, each of the auxiliary wheel and the first sheave abutting against a respective one of an inner side and the outer side of the annular chain in a same direction, to allow the flexible transmission mechanism to form a first transmission section and a second transmission section, the first transmission section being arranged horizontally and comprising the first sprocket, a preset angle being formed between the second transmission section and the first transmission section, the second transmission section comprising the second sprocket.

4. The scattered material cleaning robot for the conveyor according to claim 3, wherein the flexible transmission mechanism further comprises a second sheave abutting against an outer side of the second transmission section, to allow the annular chain to form a non-block recess below the second sprocket, the discharging assembly being arranged at the non-block recess.

5. The scattered material cleaning robot for the conveyor according to claim 4, wherein a circumferential side of the first sheave is provided with at least one first non-block notch, a circumferential side of the second sheave being provided with at least one second non-block notch, each of the at least one first non-block notch and the at least one second non-block notch being configured to unblock the at least one material carrying member.

6. The scattered material cleaning robot for the conveyor according to claim 3, wherein the scattered material cleaning robot further comprises a spacer plate fixed to the housing, the spacer plate being arranged on an inner side of the second transmission section, the spacer plate extending along a profile of the annular chain.

7. The scattered material cleaning robot for the conveyor claim 1, wherein the body further comprises a traveling component, the traveling component comprising:
a wheel axle, the wheel axle being rotatably connected to the housing;
a traveling wheel, the traveling wheel being rotatably connected to the wheel axle, the traveling wheel being movable in an axial direction of the wheel axle to a first position and a second position; and
an adjusting mechanism, the adjusting mechanism comprising a first traveling driven wheel and a second traveling driven wheel arranged around the wheel axle, each of the first traveling driven wheel and the second traveling driven wheel being connected to the driving assembly for transmission, a rotation direction of the first traveling driven wheel being opposite to a rotation direction of the second traveling driven wheel,
when the traveling wheel moves to the first position, the traveling wheel rotates in synchronization with the first traveling driven wheel,
when the traveling wheel moves to the second position, the traveling wheel rotates in synchronization with the second traveling driven wheel.

8. The scattered material cleaning robot for the conveyor according to claim 7, wherein the adjusting mechanism further comprises a cooperating member, the cooperating member and the first traveling driven wheel being fixedly connected to the wheel axle, the cooperating member being arranged on one of two sides of the traveling wheel, the second traveling driven wheel being arranged on another one of the two sides of the traveling wheel, each of the two sides of the traveling wheel being provided with a first limit surface extending in the axial direction of the wheel axle, the second traveling driven wheel being provided with a second limit surface, the cooperating member being provided with a third limit surface,
when the traveling wheel moves to the first position, the first limit surface and the second limit surface are separated from each other, and the first limit surface and the third limit surface abut against each other,
when the traveling wheel moves to the second position, the first limit surface and the second limit surface abut against each other, and the first limit surface and the third limit surface are separated from each other.

9. The scattered material cleaning robot for the conveyor according to claim 8, wherein the traveling wheel is movable in the axial direction of the wheel axle to a third position located between the first position and the second position,
when the traveling wheel moves to the third position, each of the second limit surface and the third limit surface is separated from the first limit surface.

10. The scattered material cleaning robot for the conveyor according to claim 9, wherein the adjusting mechanism further comprises a toggle member, the toggle member being rotatably connected to the housing, a rotation axis of the toggle member and a rotation axis of the housing being perpendicular to a central axis of the wheel axle, a first end of the toggle member close to the traveling wheel being provided with a first snap portion, the traveling wheel being provided with a second snap portion corresponding to the first snap portion, the first snap portion and the second snap portion abutting against each other, wherein when an external force is applied to a second end of the toggle member away from the traveling wheel, the first end of the toggle member drives the traveling wheel to move to the first position, the second position, or the third position.

11. The scattered material cleaning robot for the conveyor according to claim 10, wherein the adjusting mechanism further comprises a transition member, the transition member being slidably connected to the housing along the axial direction of the wheel axle, the transition member being provided between the first snap portion and the second snap portion, the transition member being provided with two third snap portions disposed opposite to each other, each of the first snap portion and the second snap portion abutting against a respective one of the two third snap portions.

12. The scattered material cleaning robot for the conveyor according to claim 11, wherein the scattered material cleaning robot further comprises an armrest, a rope and a handle, the armrest being fixedly connected to the housing, the handle being rotatably connected to the armrest, a first end of the rope being connected to the handle, a second end of the rope being connected to the second end of the toggle member.

13. The scattered material cleaning robot for the conveyor according to claim 12, wherein the traveling wheel, the second traveling driven wheel, the toggle member, the transition member, the rope and the handle cooperating with each other form one traveling assembly, the traveling component comprising two traveling assemblies, one of Page two traveling wheels of the two traveling assemblies being arranged at one side of the housing, and another one of the two traveling wheels of the two traveling assemblies being arranged at another side of the housing.

14. The scattered material cleaning robot for the conveyor according to claim 2, wherein the feeding assembly comprises a connecting shaft and at least one blade fixedly connected to each other, the connecting shaft being rotatably connected to the housing, the at least one blade helically extending in an axial direction of the connecting shaft.

15. The scattered material cleaning robot for the conveyor according to claim 14, wherein the connecting shaft and the first sprocket are coaxially arranged, the feeding assembly comprising two blades, one of the two blades being arranged on one side of the first sprocket, another one of the two blades being arranged on another side of the first sprocket, helical directions of the two blades being arranged opposite to each other.

16. The scattered material cleaning robot for the conveyor according to claim 7, wherein the housing comprises a first housing and a second housing fixedly connected to each other and communicating with each other, the first housing being horizontally arranged relative to a ground, the second housing being vertically arranged relative to the ground.

17. The scattered material cleaning robot for the conveyor according to claim 16, wherein an end of the first housing away from the second housing is provided with a bucket, wherein when the body moves in a forward direction, the scattered materials are shoveled into the bucket.

18. The scattered material cleaning robot for the conveyor according to claim 5, wherein the circumferential side of the first sheave is provided with two first non-block notches, the two first non-block notches being arranged opposite to each other, a spacing between the two first non-block notches along a circumferential direction of the first sheave being consistent with a spacing between two adjacent material carrying members arranged on the annular chain, the circumferential side of the second sheave being provided with two second non-block notches, the two second non-block notches being arranged opposite to each other, a spacing between the two second non-block notches along a circumferential direction of the second sheave being consistent with a spacing between two adjacent material carrying members arranged on the annular chain.

19. The scattered material cleaning robot for the conveyor according to claim 16, wherein the housing is provided with a support on each of two sides in a width direction of the body, the two supports being fixed to the second housing, each of two ends of the wheel axle penetrating through a respective one of the two supports, the wheel axle and the two supports being rotatably connected to each other.

20. The scattered material cleaning robot for the conveyor according to claim 7, wherein the traveling wheel comprises an engagement member, a hub and a wheel body, the engagement member being rotatably connected to the wheel axle, the hub being fixed to an outer peripheral side of the engagement member, the wheel body being fixed to an outer peripheral side of the hub.
